(19) United States
(12) Patent Application Publication
(10) Pub. No.: US 2007/0061834 A1
(43) Pub. Date: Mar. 15, 2007

(54) Business model for providing on demand digital content

(75) Inventor: Fabien M. J. Guillorit, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., BA Eindhoven (NL)

(21) Appl. No.: 10/570,865

(22) PCT Filed: Sep. 2, 2004
(86) PCT No.: PCT/IB04/51677

§ 371 Date: Mar. 7, 2006

Related U.S. Application Data
(60) Provisional application No. 60/501,124, filed on Sep. 8, 2003.

(51) Int. Cl. H04N 7/16

(52) U.S. Cl. 725/23

(57) ABSTRACT

A system and method for rewarding consumers who conduct purchasing transactions of content from a content provider via the Internet. A user first subscribes and sets up a user account with a content provider. Once an account is set up, a user is then enabled to conduct a purchase or on-demand streaming download of content from the content provider to a user's playback device via a network connection, e.g., Internet, and a history of user purchases of various content is stored. The reward for a transaction is based the content and particularly, on criteria including: 1) amount of time and manner in which said content has been available; and 2) a user's intended use of the content.

The present invention relates to systems for selling digital video content on demand, and particularly, a system and methodology for handling digital content programs on demand and leveraging receipt of such content for the benefit consumers.

The general public now generally enjoys several possibilities for buying commercially available content such as video, music, etc., e.g., on CD, DVD, or, on demand through the cable, typically via the Internet. However, the issue of competition linked to the access of this content and the problems of piracy, especially for streamed digital content such as for audio and video programs provided on demand, for example, presents itself.

Currently, Conditional Access (CA) systems exists that are used to control access to digital content to authorized users by encrypting the transmitted content programming. Users who are already subscribers of a cable or satellite network, may possess a CA module which is a means of allowing users to access or download only that content or services that are authorized to them, and comprises a combination of scrambling and encryption to prevent unauthorized reception. When the term is applied to a decoder, for example, a gateway such as a Set-top Box (STB), it refers to the part of the decoder which is concerned with decoding electronic keys, and recovering the information needed to control the descrambling sequence. For example, a security module, usually in the form of a smart card, extracts EMM (Entitlement Management Messages) and ECM (Entitlement Control Messages) necessary for decrypting the transmitted programs or digital content. The security module is either embedded within the STB or in a PC Card that plugs into the set-top box. As known, EMM are conditional access messages used to convey entitlements or keys to users, or to invalidate or delete entitlements or keys, and ECM are conditional access messages carrying access parameters comprising an encrypted form of control word (CW) or a means to recover the control words, to provide an identification of the service and of the conditions required for accessing the service or content. The user's set-top box houses the security module that gives authorization for decrypting the transmitted programs. The set-top box also converts the digital signal to an analog signal so an older television can display the programs.

Current approaches in CA systems includes “CryptoWorks” which is a system available from the current Assignee (Philips Inc.) that provides full range functionality for managing and controlling access to Pay-TV, access to services in any IP network, and provides full, end-to-end, content-level protection for on-demand digital streamed content.

Even after transacting and communicating content to the customer, it would be desirable for content providers to further incentivise purchases by the consumer by providing a reward system. That is, a reward or special discount system tied to consumer purchases would be highly desirable in promoting further consumer purchases and fostering competition among service/content providers.

The present invention teaches a new way for handling the dissemination and/or purchase of programs, e.g., streaming digital content on demand, or purchases, e.g., VHS-tape, audio CDs, DVDs, provided on analog or digital storage media, etc. via the Internet. Particularly, the present invention provides a way to associate a user with the purchase of digital content over the Internet through their STB, and provide additional rewards for fidelity.

According to the principles of the invention, there is provided a system and method for rewarding consumers who conduct purchasing transactions of content from a content provider via the Internet. A user first subscribes and sets up a user account with a content provider. Once an account is set up, a user is then enabled to conduct a purchase or on-demand streaming download of content from the content provider to a user's playback device via an Internet connection, and a history of user purchases of various content is stored. The reward for a transaction is based the content and particularly, on criteria including: 1) amount of time and manner in which said content has been available; and 2) a user's intended use of the content.

The objects, features and advantages of the present invention will become apparent to one skilled in the art, in view of the following detailed description taken in combination with the attached drawing, in which:

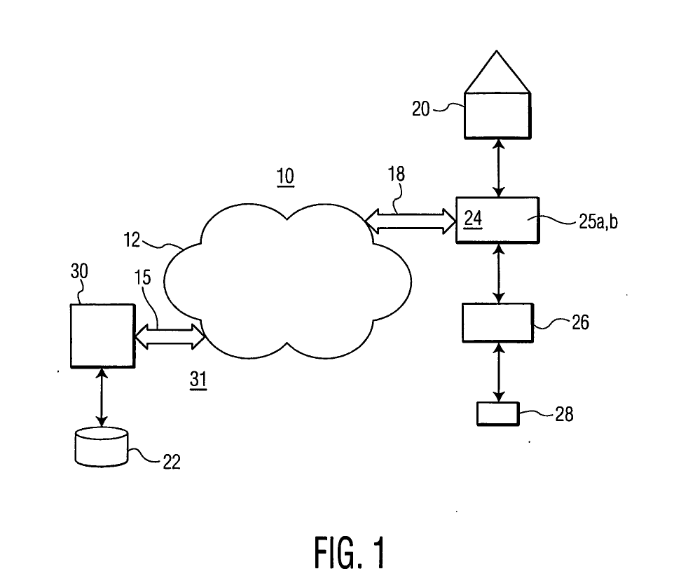

FIG. 1 depicts an environment 10 in which the reward system of the present invention is employed.

FIG. 1 depicts a business environment 10 employing the discounting reward methodology of the invention. As shown in FIG. 1, there is shown a content provider 30 which may be any commercial enterprise having a web-presence (e.g., web-site 31) enabling on-line purchase of content, whether it be streaming digital content 15 provided on-demand to the customer's home 20 via a streaming connection over the Internet 12, or an on-line purchase of content, e.g., books, analog or digital storage media, for immediate downloading via an Internet connection or, subsequently via conventional delivery systems (mail) to the customer's home 20. As shown in FIG. 1, a gateway (STB) 24 is connected at least to a cable 18 or satellite dish (not shown) for connection to a service provider, e.g., cable, TV network, satellite network, and the like. The gateway, e.g., STB 24, preferably employs the above-mentioned CA module 25a including a smart card 25a for controlling the access to the on-demand media The solution additionally assumes that there is an analog or digital connection between the gateway STB 24 and a playback device 26, such as a TV or computer, having digital or analog recording devices 28 including but not limited to: DV-RW, HD, VCR, etc., for storing purchased content on various storage media such as CD's, DVD's, hard disks (HD), VHS tape, and other non-volatile recording media, etc.

It is understood that any purchased content that is to be recorded to the user's storage device is encoded, and tagged with a key generated on the based on the CA module, with additional information regarding rights to instruct the STB what to do. For example, information may be provided to the STB to prevent playback of content, e.g., the content is not output on the digital or analog outputs (SCART, 1394), and shall be destroyed after viewing or if a pre-specified time validity expired. Finally, the content may be played back and decoded by the CA module when played back. Regarding the recording of content, the “private” field of the conditional access data from a streamed MPEG-2 TS content may be used to ensure that the content is not misused or illegally compromised. The STB will store and use the data to allow or not the user to record the movie, see it more than once, and record it on a tape from the analog STB output or even on the digital output.

In operation, a user may access the database 22 directly through Internet 12, or by conventional telephone, and that user may create an account. Using his/her favorite access control method, that user will be able to register his/her purchasing of, for example, DVD's, CD's, books, so that the content provider will able to trace that purchasing consumer. Preferably, a consumer/user will enter or otherwise provide a client number associated with that user via his/her Set top box 24 so the content provider can trace the client.

More particularly, a consumer's history of transactions are stored in a database 22, maintained and owned by the content provider, e,g., (Disney, Warner, etc.) or to a third party like a network operator that can act as a front end for several multimedia groups. According to the invention, every transaction involving the consumer gives perks or point credits to the consumer (client), which perks are preferably based on the value of the purchasing and the conditions. All points accumulated are credited to the customer's account via the Internet and stored in the database. Preferably, most of the advertising, promotions, account balance, and purchasing with points shall occur through the Internet 12 and be available for viewing by customers. According to the invention, currency, for example, dollars is converted to points. For example, when buying products/services 1 $ worth of purchased goods may credit the purchaser ten (10) point credits. It is understood that incentives may be built in. For instance, purchasing frequency shall give extra reward.

In an example case of a Video on Demand purchase, if a user buys a movie on demand for 12 $, the user may be credit 120 points. If the user buys twelve (12) movies per month at 5 $/per movie, that user will be credited 12*50 points, however, having purchased more than 10 transaction in a month, the user will be rewarded an extra 10% in points. Further, according to the invention, in the case of Video On Demand movie purchase, the price/points may change according, but not limited to, the following factors: 1) how recent is the movie, e.g., has the movie just appeared in the cinema (higher price/perks), or can be rented in a Video store, purchased in shop, or it is played on TV, in which case it probably is a classic and will be associated with a lower price/perks; and, 2) what does the user wants to do with the content, e.g., view it live after he bought it (lowest price/perks), record it in the STB for later viewing within a limited period of time (1 day, 1 week, 1 month, 1 year), view it once or several times (medium price/perks), record it on an analog or digital recording media/device external to the STB (higher price/perk). Preferably, a consumer will be able to register a purchase or on-demand download and enter intended use, such as amount of times it will be played, and whether it will be recorded in a permanent storage media.

When cashing in on an accumulated reward, a user may view the benefits (service, product) that he/she can buy with his/her perks through the Internet, via TV, advertising or, even a small review sent to the consumer's home. For example, a first run movie may require payment of 1000 points (worth of accumulated transactions), etc. Thus, for example, 100 points may have goods/services purchasing power equal to 1 $. Thus, even when a consumer purchases a movie with his/her STB the consumer will be able to pay partially or fully in points. For example, a Video on Demand movie may be advertised as costing either 10 $ or, 5 $+500 points. A dollar value of “units” may be set by the content provider. Preferably, the media group(s) or the service provider will set the rate themselves.

Further example scenarios include:
1. If a consumer purchases content from a movie studio (Disney), and he/she is also paying a subscription to view programs from the same company (Disney), that consumer will benefit from special discounts. For example, the user may purchase a recent Time Warner movie and subscribe to Time Warner TV channels, or may make special offers to their best clients (most accumulation of points) such as: inviting them to a premier or allow them to access special content in advance.
2. If the content is purchased for the purpose of recording on storage media, e.g., tape, DVD, HD, etc. via a recording device 28 (FIG. 1) the system will generate a unique number or “key” based on the Conditional Access module and the smart card 25a, 25b present in the gateway 24 (FIG. 1). This key will be recorded with the content and used as an authorization/verification mechanism for playing back (viewing) the content. Consequently, if the CA module and smart card present when the content is played by play back device 26 do not match the key recorded, the content shall not be played. This is a measure to protect against piracy. Thus, if a consumer has purchased content and has loaned the content to another party, the user would have to lend him that user's conditional access module and smart card to access the data.
3. Thus, at the time of purchasing, a user may indicate if it is for viewing once. If it is for viewing once, then the output to DVD−RW or any recording device will be disabled.
4. If the consumer specifies use of the digital content for multiple viewing but not copying or recording on removable media, then only the user's Hard disk drive (HD) will be able to record. Again, playback is enabled only if the specific combination of CA module and smart card 25a, 25b is present in the gateway device 24.
5. If the consumer specifies that he wants to record the content, then he shall pay different fee. Again the playback will be linked to the CA module and smart card 25a, 25b present in the gateway 24.
6. If the consumer purchases a CD, DVD, tape from a content provider in a shop (not on-line), and it plays it back on it system, the consumer may register his/her purchasing with the provider, e.g., through the Internet 12, and build the fidelity points to have more discounts on that consumer's next purchasing on demand or on his subscription.
7. If the consumer often purchases programs on demand, the provider may offer that consumer the fees. For example, the consumer may receive a refund back from the provider amounting to, for example, the normal monthly subscription fee (or a portion) that that user had paid if that user has purchased a pre-determined amount of programs on demand, or, that user will receive a quantity N×months free viewing of his subscription to see his content on the cable or satellite network.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A reward system for consumers (20) who conduct purchasing transactions of analog or digital content (15) from a content provider (30), said system comprising
means (31, 22) for setting up a subscribing user account and storing a history of past user purchases of various content from one or more content providers;
means enabling communication with a communications network (12), said means including interface enabling the purchase and on-demand downloading of content (15) from said one or more content providers (30) to a user's playback device (26) via a network connection;
means (31) associating a purchase transaction of content with a reward value, said reward value based on criteria including: 1) amount of time and manner in which said content has been available; and 2) a user's intended use of the content;
means (31, 22) for tracking past user purchases of content provided by each content provider, and bestowing a reward to said user based on a reward value accumulated as a result of said tracked transactions.

2. The reward system for consumers as claimed in claim 1, wherein said reward includes a user credit for purchasing additional content.

3. The reward system for consumers as claimed in claim 1, wherein said reward includes a discount when purchasing additional content.

4. The reward system for consumers as claimed in claim 1, wherein said means for tracking past user purchases of content includes memory device (22) maintained by a content provider or a third party representative for storing a history of purchase transactions.

5. The reward system for consumers as claimed in claim 1, wherein said means for enabling communication with the communications network includes a gateway device (24) employing a conditional access (CA) means (25a, 25b) for enabling controlled access to said content subsequent to its purchase.

6. The reward system for consumers as claimed in claim 5, wherein said gateway device comprises a set-top box.

7. The reward system for consumers as claimed in claim 5, further including content recording device (28) associated with said user gateway for enabling temporary or permanent storage of provided content on removable storage media.

8. The reward system for consumers as claimed in claim 7, wherein said reward value criteria includes whether a user intends to record content on removable storage media (28), said system further comprising means (18) enabling user specification of intended use via said gateway device.

9. The reward system for consumers as claimed in claim 4, wherein a purchase price for said content is based on whether a user specifies recording said content.

10. The reward system for consumers as claimed in claim 7, wherein said CA means (25a, 25b) enables controlled access to said provided content according to an amount of times the content will be played as specified by said user.

11. The reward system for consumers as claimed in claim 7, wherein said CA device enables controlled access to said provided content according to whether it will be recorded (28) in a permanent storage media.

12. A method for rewarding consumers (20) who conduct purchasing transactions of analog or digital content (15) from a content provider over a communications network (12), said method comprising steps of:
providing a subscribing user account (31, 22) for storing a history of past user purchases of various content from one or more content providers (30);
enabling communication (18, 24) with the communications network (12) and the purchase of content (15) from said one or more content providers for download to a user's playback device (26) via a communications network connection;
associating (31) a purchase transaction of content with a reward value, said reward value based on criteria including: 1) amount of time and manner in which said content has been available; and 2) a user's intended use of the content;
tracking (31, 22) past user purchases of content provided by each content provider (30), and bestowing a reward to said user based on a reward value accumulated as a result of said tracked transactions.

13. The method as claimed in claim 12, wherein said reward includes one of: providing a user credit for purchasing additional content, or providing a discount when purchasing additional content.

14. The method as claimed in claim 12, wherein said step of tracking past user purchases of content includes maintaining a memory device (22) for storing a history of purchase transactions maintained by a content provider or a third party representative thereof.

15. The method as claimed in claim 14, further including the step of: enabling a user to temporary or permanent store (28) purchased content on removable storage media.

16. The method as claimed in claim 15, wherein said reward value criteria includes whether a user intends to record (28) content on said removable storage media, said method further comprising the step of: enabling user specification of intended use via a gateway device (24).

17. The method as claimed in claim 16, further comprising the step of enabling controlled access (25a, 25b) to said content subsequent to its purchase.

18. The method as claimed in claim 15, further comprising the step of basing a purchase price for said content according to whether a user specifies recording said content.

19. The method for consumers as claimed in claim 17, wherein said step of enabling controlled access (25a, 25b) to said provided content (15) is based on whether it will be recorded in a permanent storage media (28) or will be played for a predetermined number of times.

20. The method for consumers as claimed in claim 12, wherein a user purchases content from said content provider off-line, said method comprising the step of:
enabling a user to subsequently register the purchase with said content provider (30, 31) to count the purchase transaction towards a reward.

21. A program storage device readable by a machine, tangibly embodying a program of instructions executable by the machine to perform method steps for rewarding consumers (20) who conduct purchasing transactions of analog or digital content (15) from a content provider over a communications network (12), said method steps comprising:
a) providing a subscribing user account (31, 22) for storing a history of past user purchases of various content from one or more content providers (30);
b) enabling communication (18, 24) with the communications network (12) and the purchase of content (15) from said one or more content providers for download to a user's playback device (26) via a communications network connection;
c) associating (31) a purchase transaction of content with a reward value, said reward value based on criteria including: 1) amount of time and manner in which said content has been available; and 2) a user's intended use of the content;
d) tracking (31, 22) past user purchases of content provided by each content provider (30), and bestowing a reward to said user based on a reward value accumulated as a result of said tracked transactions.
